(19) United States
(12) Patent Application Publication
(10) Pub. No.: US 2017/0135368 A1
(43) Pub. Date: May 18, 2017

(54) NOVEL FAT-FREE CONFECTIONERY ITEM

(71) Applicant: ROQUETTE FRERES, Lestrem (FR)

(72) Inventors: Raymond BRENDEL, Bethune (FR); Andre BUSOLIN, Ornex (FR)

(21) Appl. No.: 15/322,853

(22) PCT Filed: Jun. 30, 2015
(86) PCT No.: PCT/EP2015/064781

§ 371 Date: Dec. 29, 2016

(30) Foreign Application Priority Data
Jun. 30, 2014 (FR) 14 56221

(51) Int. Cl. A23G 4/06; A23L 29/212; A23L 29/30; A23G 4/10

(52) U.S. Cl. CPC A23G 4/06; A23G 4/068; A23G 4/10; A23L 29/212; A23L 29/30; A23V 2002/00

(57) ABSTRACT

Disclosed is a novel confectionery item, and more particularly a chewing gum of which the fat content has been reduced or totally eliminated. This reduction or elimination of the fat makes it possible to obtain a confectionery item that has a reduced caloric load, while keeping a texture similar to the same confectionery item containing fat. Moreover, the invention also concerns the combination of this novel confectionery item with already existing confectionery items in order to create novel textures and flavours. The present invention also concerns a method for preparing such a confectionery item.

### FIELD OF THE INVENTION

The present invention relates to a novel confectionery, more particularly a chewing paste, the fat content of which has been reduced or even entirely eliminated. This reduction or elimination of the fat makes it possible to obtain a confectionery which has a reduced calorie content, while retaining a similar texture to the same confectionery containing fat. Moreover, the invention also relates to the combination of this novel confectionery with already existing confectioneries in order to create novel textures and tastes.

The present invention also relates to a process for preparing such a confectionery.

### TECHNICAL BACKGROUND

Confectionery products are numerous. Their common point is the cooking of sugar and/or polyols and the mixing thereof with other ingredients to obtain different flavors and specialties. Confectioneries especially consist of sugars or polyols, sweeteners, fat, emulsifiers, flavors, colorings, inorganic and/or organic acids and/or bases and salts thereof, and one or more thickening and/or gelling hydrocolloids of plant or animal origin such as gum arabic, gelatin, pectin, carrageenans, alginates, celluloses and starch and derivatives thereof.

Chewing pastes may be obtained by cooking a mixture of sugar and glucose syrup to which fat has been added. Traditionally, conventional chewing pastes contain between 4 and 8%, sometimes 10%, fat. The cooked mass may then be aerated to lighten it, by one of the methods well known to confectioners such as for example pulling, beating, optionally under pressure, mixing under pressure, or extrusion. It is this aeration in the presence of fats which gives chewing pastes their characteristic texture.

The present invention relates to all confectioneries of chewing paste type which traditionally contain fat.

The fat used in confectioneries may be of different origins. Most frequently, it is hydrogenated palm oil. In certain cases, it may also be coconut oil.

Palm oil is currently highly used in the food-processing industry (80% of the applications are concerned). Its very low production cost, ability to preserve foods and to make them soft make this product a key element in the industry.

Indeed, the way our diet is made up has changed profoundly. From entirely natural home-cooked foods, our diet has come to include more and more foods which have been transformed by the food-processing industry. In developed countries, this transformation has been accompanied by an increase in the contribution made by fatty acids, the latter having increased from 25% to 45% of our energy intake. However, this increase has occurred to the detriment of cis unsaturated fatty acids and in favor of trans saturated fatty acids, the deleterious effects of which on our health are numerous. Among these, mention may be made of cardiovascular diseases, obesity, diabetes, and also, quite surprisingly, depression.

For the food-processing industries, the ideal dietary fat should have a solid consistency at room temperature, which affords better stability to the food. This is why refined vegetable oils, which are liquid at room temperature since they contain a sufficient proportion of unsaturated fatty acids, have been set aside in favor of margarines which are rich in saturated fatty acids.

The ideal fat must also contribute to the good preservation of the food by preventing it from taking on a bitter smell and unpleasant taste on contact with the air, which is what happens when food turns rancid, caused by the peroxidation of unsaturated fatty acids. It is therefore necessary to replace “good” unsaturated fatty acids contained in refined vegetable oils, including palm oil, with saturated fatty acids. The melting point thereof must not however be too high, otherwise they will give a waxy taste to the finished product.

Moreover, the ideal dietary fat should give the sensation of a soft texture and appetizing tastes. Thus, in pastries, a melt-in-the-mouth sensation is favored. Finally, to avoid this fat releasing any potentially carcinogenic compounds, it must be ensured that it does not degrade rapidly at cooking temperatures, and that it does not have any allergenicity. These characteristics should preferably be obtained with a low production cost, so as not to overly burden consumer spending. This was a brief description of the specifications of the food industry, which has developed various techniques for treating oils, especially palm oil, in order to obtain the abovementioned qualities.

Palm oil should really be called “palm fat” since it is solid at room temperature, due to its high content of saturated fatty acids (which is far higher than that of animal fats such as butter, for example).

It is found in a wide range of products such as biscuits, confectioneries, mass-produced breads, chocolate bars, cereals, margarine, ice cream, etc. (but also in some soaps, perfumes, cosmetics, etc.).

Like trans fatty acids, saturated fatty acids also increase bad cholesterol. Thus, adding fat which is rich in saturated fatty acids (here, palm oil) to a foodstuff which is already rich in saturated fatty acids is detrimental to health.

Moreover, palm oil production is associated with mass deforestation, greenhouse gas emissions and a negative impact on biodiversity.

Recently, a reversal of trend has been observed. In order to combat these harmful ecological and health-based effects, several big chains (fast food, superstores, food-processing companies, etc.) have chosen to significantly reduce, or even completely eliminate, the use of palm oil in the production of their food products.

The present invention is concerned with this perspective because it makes it possible to reduce, or even totally eliminate, fat in confectioneries, and more particularly confectioneries of the chewing paste type.

There is therefore a need to totally or partially replace the fat in confectioneries, while giving the confectioneries the desired properties, which are: a satisfactory visual appearance, an absence of stickiness either in the mouth or in the final packaging, a texture in the mouth as close as possible to the control with fat, and satisfactory stability with regard to hardening or softening over time.

### SUMMARY OF THE INVENTION

Armed with this finding and after numerous research studies, it is to the credit of the applicant company to have satisfied all the demands required and to have found that such an objective could be achieved provided that a particular combination of a starch hydrolyzate, in particular a maltodextrin, and a fiber, is used.

It is therefore to the credit of the applicant to have discovered that a combination of a starch hydrolyzate and a plant fiber could, surprisingly and unexpectedly with respect to the prerequisites of the prior art, advantageously replace fat in confectioneries, in particular of the chewing paste type, while at the same time preserving organoleptic qualities, in particular gustative, olfactory, visual and tactile properties, at least equivalent to or even greater than those of the conventional confectioneries containing fat. Moreover, the invention also makes it possible to improve the preservation time of the confectioneries by avoiding problems of confectioneries turning rancid, generally linked to the oxidation of the fats.

The confectioneries which are a subject of the invention also exhibit a lesser phenomenon of deformation linked in some cases to a softening of the fat.

The present invention therefore relates to a confectionery, in particular of chewing paste type, having a reduced or zero fat content, characterized in that it comprises a mixture of a starch hydrolyzate, in particular a maltodextrin, and a plant fiber.

In one particular embodiment, the confectionery according to the invention comprises a fat content of less than 3%, the percentage being expressed by weight relative to the total weight of the confectionery.

Said confectionery is characterized in that it comprises from 0.1% to 25% of a starch hydrolyzate, preferably from 2% to 10%, more preferentially from 3% to 8%, the percentages being expressed by weight relative to the total weight of the confectionery. It is also characterized in that it comprises from 0.1% to 50% fiber, preferably from 1% to 10%, more preferentially from 1% to 6%, the percentages being expressed by weight relative to the total weight of the confectionery.

According to an advantageous embodiment, said confectionery according to the invention does not contain gelatin and/or sugar.

According to one preferred mode, the maltodextrin has a DE of less than 10, and more preferentially still a DE of less than 5.

According to an even more preferred mode, the starch hydrolyzate is a maltodextrin which has a DE equal to 2.

In the confectionery according to the invention, the plant fiber is chosen from soluble fibers, insoluble fibers, or mixtures thereof.

According to one preferred mode, the insoluble plant fiber is chosen from resistant starches, cereal fibers, fruit fibers, vegetable fibers, leguminous plant fibers, or mixtures thereof.

According to another preferred embodiment of the invention, the soluble plant fiber is chosen from fructans, including fructooligosaccharides (FOSs) and inulin, glucooligosaccharides (GOSs), isomaltooligosaccharides (IMOs), transgalactooligosaccharides (TOSs), pyrodextrins, polydextrose, branched maltodextrins, indigestible dextrins or soluble oligosaccharides derived from oleaginous plants or protein-producing plants.

According to a more preferential mode, the soluble plant fiber is a branched maltodextrin.

According to a particular embodiment, the confectionery according to the invention contains a gum base, in particular from 5% to 50% by weight of gum base.

According to a particular embodiment, the confectionery according to the invention does not contain polyols.

The invention also relates to the use of a mixture of a starch hydrolyzate, in particular a maltodextrin, and a plant fiber as substitute for fat in a confectionery, in particular in a chewing paste.

The invention also relates to a chewing gum composition containing, with the percentages being given as dry weight relative to the total weight of said chewing gum composition:
from 5% to 25%, preferentially from 7% to 22%, of at least one gum base,
from 5% to 90%, preferentially from 20% to 80%, and more preferentially still from 30% to 75% of the confectionery according to the invention,
from 0.1% to 8%, preferentially from 0.1% to 3%, of at least one flavor.

The invention also relates to the process for manufacturing this chewing gum composition, characterized in that it comprises the following steps:
mixing said confectionery with the gum base,
rolling or extruding the mixture,
recovering the chewing gums.

### DETAILED DESCRIPTION OF THE EMBODIMENTS

A subject of the present invention is a novel confectionery, in particular a chewing paste, characterized in that it has a reduced or even zero fat content, and comprising a mixture of a starch hydrolyzate and a plant fiber.

In one preferential mode, the present invention relates to a novel confectionery comprising from 0.1% to 25% of a starch hydrolyzate, preferably from 2% to 10%, more preferentially from 3% to 8%, the percentages being expressed by weight relative to the total weight of the confectionery.

In another preferential mode, the present invention relates to a novel confectionery comprising from 0.1% to 50% fiber, preferably from 1% to 10%, more preferentially from 1% to 6%, the percentages being expressed by weight relative to the total weight of the confectionery.

The chewing pastes concerned by the present invention are characterized by the presence of fats which give them a soft and supple texture, as opposed to cooked sugars.

Chewing pastes also contain incorporated air and the sugar is generally partially crystallized so as to obtain a short texture. Glucose syrups contribute to the texture by facilitating the formation of a gelled network and also the correct overrun of the product.

Chewing pastes are greatly appreciated by consumers for their property of high chewability, making them similar to chewing gum. Unlike chewing gum, chewing paste dissolves totally in the mouth after chewing and does not leave any inconsumable residue.

Chewing pastes do not include binding caramels or any other confectionery in liquid or semi-liquid form.

It is to the applicant's credit to have found that the use of a combination of a starch hydrolyzate and a fiber in a confectionery which usually contains fat makes it possible to partially or totally substitute this fat while making it possible to obtain confectioneries having all the organoleptic and physical characteristics of a confectionery containing said fat.

In the present invention, the term “starch hydrolyzate” denotes any product obtained by acid or enzymatic hydrolysis of starches of leguminous plants, cereals or tubers. Various hydrolysis processes are known and have been described generally on pages 511 and 512 of the book Encyclopedia of Chemical Technology by Kirk-Othmer, 3rd edition, vol. 22, 1978. These hydrolysis products are also defined as purified and concentrated mixtures formed from linear chains consisting of D-glucose units and of D-glucose polymers which are essentially α(1-4)-linked with only from 4% to 5% of α(1-6) branched glycosidic linkages, of extremely varied molecular weights, which are completely soluble in water. Starch hydrolyzates are very well known and perfectly described in the Encyclopedia of Chemical Technology by Kirk-Othmer, 3rd edition, vol. 22, 1978, pp. 499 to 521.

According to the invention, the starch hydrolyzate is non-fibrous.

The starch hydrolysis product comprises maltodextrins, glucose syrups, dextrose (crystallized form of α-D-glucose) or mixtures thereof.

The distinction between starch hydrolysis products is based mainly on the measurement of their reducing power, conventionally expressed by the notion of Dextrose Equivalent or DE. The DE corresponds to the amount of reducing sugars, expressed in dextrose equivalent for 100 g of solids of the product. The DE therefore measures the strength of the starch hydrolysis, since the more the product is hydrolyzed, the more it contains small molecules (such as dextrose and maltose, for example) and the higher its DE. Conversely, the more the product contains large molecules (polysaccharides), the lower its DE.

From a regulatory point of view and also within the meaning of the present invention, maltodextrins have a DE of from 1 to 20, and glucose syrups have a DE of greater than 20. Such products are for example the dehydrated glucose syrups and maltodextrins sold by the applicant under the names GLUCIDEX® (DEs available=1, 2, 6, 9, 12, 17, 19 for the maltodextrins and DE=21, 29, 33, 38, 39, 40, 47 for the glucose syrups). Mention may also be made of the glucose syrups sold by the applicant under the name “Roquette sirops de glucose”.

According to the invention, the starch hydrolyzate is characterized in that it is a maltodextrin, preferably a maltodextrin having a DE of less than 10, and more preferentially still a maltodextrin having a DE of less than 5.

According to a particularly advantageous embodiment of the invention, the maltodextrin has a DE equal to 2.

The confectionery according to the invention also comprises a plant fiber.

In the present invention, the term “plant fiber” denotes soluble and/or insoluble dietary plant fibers. Plant fibers do not comprise starch hydrolyzates.

Plant fibers do not only denote fibrous materials in the strict sense, but also a whole series of different compounds which are contained virtually exclusively in foods of plant origin and which have the common property of not being able to be decomposed by human digestive enzymes. Almost all dietary fibers are carbohydrate polymers. For a few years, nutritionists have been interested in a new type of dietary fiber: resistant starch. This is a starch or a starch fraction which is not digested in the small intestine and which is fermented by the bacteria of the colon.

Unlike conventional plant fibers, these starches have the advantage of not modifying the appearance of the product into which they are incorporated and constitute as it were a source of fibers that is invisible to the naked eye. These starches are recommended in many applications.

Thus, in the present invention, the plant fiber is chosen from soluble fibers, insoluble fibers, or mixtures thereof.

According to a first advantageous embodiment of the invention, the plant fiber is an insoluble plant fiber, chosen from resistant starches. Natural resistant starches or resistant starches obtained by chemical and/or physical and/or enzymatic modification may be used without implied distinction.

According to the present invention, the term “resistant starch” denotes a starch or a starch fraction which is not digested in the small intestine and which is fermented by the bacteria of the colon. Four categories of resistant starch have been identified:
encapsulated starches, present in most unrefined vegetable foods such as dried vegetables, said starches being inaccessible to enzymes (RS1),
the granular starch of certain raw foods, such as banana or potato, and amylose-rich starches (RS2),
retrograded starches, which are found in foods that have been cooked and then refrigerated or frozen (RS3),
chemically modified starches such as, in particular, etherified or esterified starches (RS4).

The resistant starches proposed in particular by the company NATIONAL STARCH, such as those sold under the name HI-MAIZE®, are derived from amylose-rich corn varieties and behave like insoluble fibers. RS3-type resistant starches are also proposed under the name NOVELOSE®.

These resistant starches decrease the glycemic response, improve the health of the digestive system by virtue of their prebiotic properties and contribute to the regularity of transit, without having a high calorie content.

According to one advantageous embodiment of the present invention, the confectionery comprises a mixture of a maltodextrin and a soluble plant fiber.

According to this embodiment, the confectionery comprises from 0.1% to 50% fiber, preferably from 1% to 10%, more preferentially from 1% to 6%, the percentages being expressed by weight relative to the total weight of the confectionery.

In this advantageous embodiment of the present invention, the confectionery comprises from 1 to 6% fibers. Thus, the phrase “fiber-rich” or “source of fiber” may be added to the packaging of said confectionery, which represents an additional advantage in terms of nutrition and marketing. This will be demonstrated in the examples below.

The applicant company has not only reduced or even eliminated the fats traditionally contained in the confectioneries which are a subject of the present invention, but have also enriched the latter in fibers. The advantage of the invention is therefore dual.

Preferably, said soluble plant fiber is chosen from fructans, including fructooligosaccharides (FOSs) and inulin, glucooligosaccharides (GOSs), isomaltooligosaccharides (IMOs), transgalactooligosaccharides (TOSs), pyrodextrins, polydextrose, branched maltodextrins, indigestible dextrins and soluble oligosaccharides derived from oleaginous plants or protein-producing plants or mixtures thereof.

The term “soluble fiber” is intended to mean water-soluble fibers. The fibers can be quantitatively determined according to various AOAC methods. Mention may be made, by way of example, of AOAC methods 997.08 and 999.03 for fructans, FOSs and inulin, AOAC method 2000.11 for polydextrose, AOAC method 2001.03 for quantitatively determining the fibers contained in branched maltodextrins and indigestible dextrins, or AOAC method 2001.02 for GOSs and also soluble oligosaccharides derived from oleaginous or protein-producing plants. Among the soluble oligosaccharides derived from oleaginous or protein-producing plants, mention may be made of soya, rapeseed or pea oligosaccharides.

According to one advantageous embodiment of the present invention, the confectionery comprises a mixture of a maltodextrin and soluble plant fibers which are branched maltodextrins.

The term “branched maltodextrins (BMDs)” is intended to mean the specific maltodextrins identical to those described in patent EP 1006128-B1 of which the applicant is the proprietor. These BMDs have the advantage of representing a source of indigestible fibers beneficial to the metabolism and to intestinal equilibrium.

According to the present invention, said branched maltodextrins are characterized in that they have
between 15% and 50% of 1-6-glycosidic linkages, preferentially between 22% and 45%, more preferentially between 20% and 40%, and even more preferentially between 25% and 35%,
a reducing sugar content of less than 20%, preferentially between 2% and 20%, more preferentially between 2.5% and 15%, and even more preferentially between 3.5% and 10%,
a polydispersity index of less than 5, preferentially of between 1 and 4, more preferentially between 1.5 and 3, and
a number-average molecular weight Mn of less than 4500 g/mol, preferentially between 400 and 4500 g/mol, more preferentially between 500 and 3000 g/mol, more preferentially still between 700 and 2800 g/mol, even more preferentially between 1000 and 2600 g/mol.

In particular, use may be made of BMDs having between 15% and 35% of 1-6-glycosidic linkages, a reducing sugar content of less than 20%, a weight-average molecular weight Mw of between 4000 and 6000 g/mol and a number-average molecular weight Mn of between 250 and 4500 g/mol.

Certain BMD subfamilies described in the abovementioned application can also be used in accordance with the invention. These are, for example, high-molecular-weight BMDs having a reducing sugar content at most equal to 5 and an Mn of between 2000 and 4500 g/mol. Low-molecular-weight BMDs having a reducing sugar content between 5% and 20% and a molecular weight Mn of less than 2000 g/mol can also be used.

In another advantageous embodiment of the present invention, use may also be made, in accordance with the invention, of the hypoglycemic hyperbranched maltodextrins described in application FR 1251810 of which the applicant is the proprietor.

In the present application, pyrodextrins denote the products obtained by heating starch brought to a low moisture content, in the presence of acid or basic catalysts, and generally having a molecular weight of between 1000 and 6000 Daltons. This dry roasting of the starch, usually in the presence of acid, brings about both a depolymerization of the starch and a rearrangement of the starch fragments obtained, resulting in the obtaining of highly branched molecules. This definition targets in particular the “indigestible” dextrins, having an average molecular weight of about 2000 Daltons.

Polydextrose is a soluble fiber produced by thermal polymerization of dextrose, in the presence of sorbitol and of acid as catalyst. An example of such a product is, for example, LITESSE® sold by DANISCO.

According to one particularly advantageous mode of the present invention, the confectionery comprises NUTRIOSE®, which is a complete range of soluble fibers, recognized for their benefits, and manufactured and sold by the applicant. The products of the NUTRIOSE® range are partially hydrolyzed wheat or corn starch derivatives which contain up to 85% fiber. This richness in fiber makes it possible to increase digestive tolerance, to improve calorie control, to prolong energy release and to obtain a lower sugar content. Furthermore, the NUTRIOSE® range is one of the best tolerated fibers available on the market. It shows a higher digestive tolerance, enabling better incorporation than other fibers, which represents real dietary advantages.

There are many advantages to adding fibers, and more particularly branched maltodextrins such as NUTRIOSE®, to the confectionery of the present invention. Aside from the nutritive aspect and the provision of fibers that are very well-tolerated by the body, the addition of these fibers also has a not insignificant technical value. Indeed, these fibers consist of long polymeric carbohydrate chains and therefore act as a texturing agent in the confectioneries. The presence of fibers therefore makes it possible to further increase the elasticity of the final product.

Thus, the durability of the chewability is increased by the presence of these long chains which modify the texture of the product. Their branched nature considerably and advantageously decreases their tendency to retrograde, thereby making it possible to envisage their use in jelly confectioneries where the absence of retrogradation is necessary, in particular during prolonged storage.

The presence of branched maltodextrins makes it possible to avoid the cold flow phenomena encountered in confectioneries produced by casting on a cooling table after cooking all the ingredients. In this type of production process, the cold flow phenomenon may be observed. This is the capacity of the chewing paste or of the caramel to deform without any force being applied. The confectionery will therefore have a tendency to run and to be crushed under the effect of its own weight. This is a fault that confectioners wholeheartedly seek to avoid.

The presence of branched maltodextrins also makes it possible to increase the glass transition temperature or Tg of the amorphous part of said confectionery. This increase in the Tg makes it possible to stiffen the structure within the confectionery and consequently makes it possible to provide a good chewability staying power.

A subject of the present invention is therefore a novel confectionery, characterized in that it has a reduced or even zero fat content, and comprising a mixture of a starch hydrolyzate, and preferably a maltodextrin, and more preferentially still a maltodextrin with a DE of less than 5, and a plant fiber, preferably a branched maltodextrin.

Another subject of the present invention is the use of a mixture of a starch hydrolyzate, in particular a maltodextrin, and a plant fiber as substitute for fat in a confectionery, in particular a chewing paste.

The use of such a composition makes it possible to partially or totally substitute the fat traditionally contained in the confectioneries in question, without thereby affecting the final organoleptic qualities of the product.

Indeed, fat is necessary in terms of the texture of this type of confectionery. Traditionally, confectioneries of chewing paste type contain fat in order to soften their texture and to reduce the phenomenon of sticking to the teeth. Without fat, the confectionery becomes dry, brittle, and even rough.

Numerous research studies have been carried out in order to reduce, or even totally eliminate, fat in confectioneries. To the applicant company's knowledge, no solution currently exists.

And yet, there are multiple advantages in seeking to substitute the fat in confectioneries. Firstly, there is a nutritional advantage. By succeeding in reducing or totally eliminating fat, the total calorie content of said confectionery is also reduced.

A second advantage is also, as explained above, substituting hydrogenated palm oil, which is detrimental to health.

The fat traditionally present in confectioneries is sensitive to high heat. It softens the product and may cause deformation problems, sometimes with modifications of the texture. Thus, by seeking to eliminate it, this type of problem linked to climatic conditions can be dispensed with.

Another advantage in substituting fat is to dispense with problems of oxidation of the terpenes contained in certain citrus-type flavors. This is because the fat is sensitive to oxidation and turning rancid.

Finally, the fat used is very often hydrogenated palm oil and is naturally immiscible with the other ingredients in the recipe. Thus, during the process of preparing the confectionery, it is frequently necessary to include a phase for dispersion (or emulsion) in the mass. Said fat can also, throughout the process, give rise to a phenomenon of exudation, that is to say rise to the surface of the product and make it shiny and most of all sticky.

By virtue of their numerous research studies, the applicant company has succeeded in demonstrating that the combination of a starch hydrolyzate and a plant fiber, and more specifically the combination of a maltodextrin and a branched maltodextrin, makes it possible to give the required suppleness to the confectionery while avoiding the phenomenon of sticking, usually avoided by using fat.

Moreover, all the abovementioned difficulties have been overcome.

The confectioneries manufactured according to the invention have an identical, or even better, texture to-than the confectioneries traditionally containing fat. Usually, the final quality of the confectioneries of the prior art manufactured by partially substituting the fat was always inferior and defects were very frequently observed: either the confectioneries were too hard, or they were too soft, or they were very sticky, or they disintegrated very quickly, often too quickly. In short, the texture obtained was not in line with consumer requirements.

The present invention makes it possible to overcome all these defects by proposing a solution which ensures that confectioneries are obtained, the texture of which corresponds perfectly to consumer requirements. Said confectioneries have a perfect elastic texture, neither too hard nor too soft. Moreover, the chewability time is increased and makes it possible to obtain confectioneries which do not disintegrate too quickly when they are consumed and which therefore make it possible for the consumer to have an entirely satisfactory chewing time.

According to a preferential embodiment of the invention, the confectionery does not contain fat.

The invention is just as applicable to confectioneries traditionally containing sugar and/or gelatin.

According to a preferred mode of the invention, the confectionery is sugar-free and gelatin-free.

Surprisingly and unexpectedly, the mixture according to the invention of a starch hydrolyzate and a plant fiber, and more specifically the mixture of a maltodextrin and a branched maltodextrin, also makes it possible to formulate confectioneries which do not contain fat and gelatin and/or sugar.

According to a preferential mode of the invention, a subject of the present invention is a novel confectionery, in particular a chewing paste, characterized in that it does not contain fat, gelatin and/or sugar and in that it contains a mixture of a starch hydrolyzate and a plant fiber.

According to the present invention, the confectioneries may also comprise gum arabic. Gum arabic is a complex and variable mixture of oligosaccharides, polysaccharides and glycoproteins of arabinogalactan. Depending on the source, the glycan constituents contain a greater proportion of L-arabinose relative to D-galactose (Acacia seyal) or of D-galactose relative to L-arabinose (Acacia senegal). The gum of Acacia seyal also contains significantly more 4-O-methyl-D-glucuronic acid but less L-rhamnose and unsubstituted D-glucuronic acid than Acacia senegal.

Its role in confectionery is to adjust the texture and bring more or less elasticity to the confectionery in which it is used. It makes it possible, for example, to extend the chewability of the confectionery in which it is used, that is to say the time required to chew the confectionery until it has completely disintegrated.

Although its use has advantages, it is not obligatory in the present invention.

The confectioneries according to the invention may also contain one or more sweeteners. Various sweeteners may be used, such as sugars or polyols, in powder or syrup form. The sugars are chosen from monosaccharides, disaccharides, trisaccharides, oligosaccharides and polysaccharides, such as, for example, glucose syrups, glucose-fructose syrups, fructose-glucose syrups, high-maltose glucose syrups, sucrose, fructose, maltose, trehalose, mannose, dextrose, tagatose or isomaltulose, alone or as a mixture with one another. The polyols are chosen from maltitol, sorbitol, mannitol, erythritol, xylitol, iditol, maltitol syrups, isomalt, lactitol, sorbitol syrups and hydrogenated glucose syrups, alone or as a mixture with one another. It is also possible to use any sort of intense sweeteners, for example saccharin, aspartame or acesulfame K, used alone or in mixtures.

According to the invention, the sweetener preferably represents 25% to 85%, preferably 40% to 85% and more preferentially from 60% to 85% by total weight of the confectionery.

The confectioneries according to the invention may also comprise one or more compounds chosen from non-reducing sugars, emulsifiers, preservatives, overrun agents, foaming agents, gelling agents, humectants, acidifying agents, natural or synthetic flavors, taste enhancers, vitamins, pharmaceutical active agents, minerals such as calcium or magnesium or other food supplements such as, for example, DHA, natural or synthetic dyes, salts, acids, or various elements intended either to improve the quality, or to flavor the composition, such as dry fruits, candied fruits, fruits which have been dried or otherwise transformed (pressed, concentrated, in powder form), and also fruit purees and fruit pulps, which are generally present in said confectioneries in an amount of 0 to 30% by weight relative to the total weight of the confectionery.

In addition, a subject of the present invention is a process for preparing confectioneries, characterized in that it comprises the steps of:
preparing a mixture comprising from 0.1% to 25% of a starch hydrolyzate, preferably from 2% to 10%, more preferentially from 3% to 8%, the percentages being expressed by weight relative to the total weight of the confectionery, and from 0.1% to 50% of a plant fiber, preferably from 1% to 10%, more preferentially from 1% to 6%, the percentages being expressed by weight relative to the total weight of the confectionery,
cooking the mixture at a temperature of between 100 and 150° C., until the desired solids are obtained,
pulling the cooked mixture,
cooling,
cutting up,
recovering the confectioneries and optional wrapping.

According to the invention, and for a continuous production, it is preferred to disperse the sweeteners, the starch hydrolyzate and the fibers in a mixing tank, to preheat this mixture to approximately 70-80° C. in order to dissolve the sweeteners, to cook the mixture on a high-pressure cooker at a temperature of between 100 and 150° C. depending on the desired texture and the type of confectionery prepared, and then to add the emulsifier, the overrun agent(s), the flavors, the dyes, the active ingredients and the intense sweeteners. The temperature for cooking the mixture will be less than or equal to 150° C., which constitutes one of the advantages of the present invention. The cooking time depends on the equipment used.

The cooking can be carried out on jacketed cookers at atmospheric pressure, under partial or total vacuum or under pressure, or continuously on high-pressure cookers such as tubular exchangers, plate exchangers or jet-cookers. The jet-cooker may comprise one or more steam injectors, thereby modifying the cooking times. Injection of live steam into the product provides rapid and homogeneous dispersion of the heat and of the ingredients. The tubular exchanger requires a homogeneous dispersion of all the ingredients before cooking, the cooking times are longer and the intensity less strong.

After cooking, the emulsifier, the overrun agent(s) and the flavors, dyes, acids and others are added to the hot syrup at a temperature of between 60 and 90° C., the mixture is then cast on a cooling plate, and pulling is carried out for approximately one minute at 50-60 movements. Once the pulling has been carried out, the confectioneries obtained are shaped and wrapped.

The applicant company has developed its research and demonstrated that the confectionery according to the invention could also be combined with other already existing confectioneries in order either to create novel confectioneries with textures different from the existing confectioneries already on the market, or in order to solve the technical problems hitherto unsolved by the solutions of the prior art.

Surprisingly and unexpectedly, it has been demonstrated by numerous tests that the confectionery according to the invention could be used in a recipe for producing chewing gum.

Current chewing gum compositions, formulated with or without sugar, of bubble-gum or non-bubble-gum type, optionally sugar-coated, contain at least one non-hydro-soluble gum base, at least one sugaring agent in powder and/or liquid form, and at least one flavor. They may also contain, nonexhaustively, dyes, emulsifiers, plasticizers, intense sweeteners, food lubricants, pharmaceutical agents, or water.

The manufacture of sugar-free chewing gum or bubble gum centers, also called tabs, requires the mixing of gum base with polyols, used as filling sweeteners.

In standard recipes for producing sugar-free chewing gum, the gum base typically represents between 28% and 40% of the ingredients used in the manufacture of the centers, the rest predominantly consisting of polyols, and to a lesser extent of intense sweeteners of aspartame or acesulfame-K type, flavors, and antioxidants in some cases.

The nature of the gum base is also adapted to the type of chewing gum produced. It may also comprise synthetic and/or natural elastomers such as polyisoprene, polyvinyl acetate, polyisobutylene, latices, resins such as terpene resins, polyvinyl alcohols and esters, fats or waxes such as, for example, lanolin, partially hydrogenated or non-partially hydrogenated vegetable oils, fatty acids, partial esters of glycerol, paraffin, microcrystalline waxes, fillers such as talc, calcium carbonate, elastomeric plasticizers such as glyceryl triacetate, glyceryl monostearate, rosin derivatives, emulsifiers such as lecithin, sorbitol esters, dyes or whitening agents, antioxidants, and non-stick agents such as mannitol.

The filling sweeteners consist of a mixture of unfermentable saccharides that may be chosen from isomaltulose, xylose, xylulose, allulose, arabinose, leucrose, tagatose, trehalulose or raffinose.

The filling sweeteners may also consist of unfermentable saccharides and polyols that may be chosen from isomaltulose, xylose, xylulose, allulose, arabinose, leucrose, tagatose, trehalulose or raffinose.

The filling sweeteners preferably consist solely of polyols.

Polyols play a crucial role in the manufacture of sugar-free chewing gum centers, both in the final quality of the product obtained (impact on the sweet taste and “long-lasting” effect, impact on the flavoring and “long-lasting” effect, crunchiness, hardness, chewability), but also in the process for preparing said centers. Typically, the main polyols used in the production of sugar-free chewing gum or bubble gum are maltitol, sorbitol, isomalt, mannitol and xylitol. These polyols are used both in powdery crystalline form and in liquid form in the formulation of these centers. A sugar-free chewing gum composition generally contains between 65 and 80% polyols, in pulverulent and/or liquid form.

The gum base recipe often remains secret since it is not constant. It varies depending on the price of the raw material. The ingredients constituting the gum base are insoluble in water. On the contrary, the majority of the ingredients constituting the chewing gums, except the gum base, is soluble in water (in this case, that is to say in saliva). After 3 or 4 minutes of chewing time, the compounds are extracted (dissolved) by the saliva, which gives rise to the loss of flavor of the chewing gum. What remains in the mouth are the gum base and the few flavors which are not water soluble, and/or which have remained trapped in the matrix constituted by the gum base.

The flavors, sweeteners or sugar and also various additives and manufacturing auxiliaries (such as dye, emulsifier, stabilizer, bicarbonate) are added to this gum base. The ingredients and the gum base are mixed in a kneader for 15 to 20 minutes. At the end of kneading, the paste reaches a temperature of about 50° C. The chewing gum paste is placed in an extruder. Once correctly pressed, it forms more or less thick strips. The strips then pass through the roller and are cut into tablets or cores also known as centers. After cooling, the tablets or centers are maintained at a controlled temperature and humidity for 6 to 48 hours. This phase is carefully controlled, since the quality of the chewing gums is dependent thereon.

The tablets are enveloped in aluminum wrapping to conserve all their taste. They are then placed in packets. The centers are sugar-coated before being wrapped in cardboard or plastic containers.

Irrespective of the age of the consumers, there is a permanent desire to have quality products. The quality of chewing gums is measured by several parameters, including the texture of the chewing gum (rather hard or, on the other hand, rather soft, persistent crunchiness of the sugar coatings during chewing) and the taste (sweet taste, refreshing effect or otherwise, persistence of the flavor during chewing). Specifically, consumers very often complain that both the crunchiness and the taste disappear too quickly during chewing.

Thus, in one particularly advantageous embodiment, the present invention also relates to the use of the confectionery according to the invention as an ingredient in the manufacture of chewing gums.

In one preferential mode, the confectionery according to the invention used in a traditional chewing gum recipe will not contain fat.

The use of the confectionery according to the invention in a standard chewing gum recipe makes it possible to partially or totally substitute the crystalline phase traditionally contained in this chewing gum recipe.

Thus, in one preferential mode, the crystalline phase of the chewing gum is partially replaced by the amorphous phase of the confectionery according to the invention.

Chewing gums contain a significant crystalline phase, which may represent up to 80% by dry weight of the ingredients used. This crystalline phase gives products which have a hard bite during chewing, and take a long time to be hydrated. The use of the confectionery according to the invention as substitute for the crystalline phase makes it possible to obtain a suppler texture which is hence easier to hydrate. This quicker ability to dissolve will enable, during tasting, a more instantaneous release of the flavors and/or acids contained in the recipe. Thus, the flavor perception will be quicker and more intense. This is referred to as a “sensory boost”.

In the past, the applicant company had already carried out tests on the partial substitution of the crystalline phase in a chewing gum recipe by a conventional chewing paste which therefore contained fat. The substitution percentages very quickly reached saturation point, due to the presence of fat in the composition. This is because the fat acts as plasticizer for the gum base in the chewing gum and ends up destroying the structure thereof when it is used in too great an amount. Due to the absence of fat in the confectionery used, substitution of the crystalline phase in a chewing gum recipe is no longer limited.

According to one embodiment of the invention, there may be total substitution of the crystalline phase in a chewing gum by the confectionery according to the invention. The confectionery according to the invention may therefore be used to prepare a chewing gum which does not contain a crystalline phase.

The confectionery according to the invention may thus be a chewing gum containing a gum base, in particular from 5% to 50% by weight of gum base, and a mixture of a starch hydrolyzate and a plant fiber.

According to a particular embodiment, said chewing gum does not contain polyols.

This reduction or even elimination of the crystalline phase (polyols, in the majority of cases) makes it possible to greatly reduce intestinal problems (bloating, flatulence, laxative effect) linked to too high a consumption of polyols.

The use of the confectionery according to the invention in a standard chewing gum recipe affords several other not insignificant advantages.

The introduction of the confectionery into a chewing gum recipe also makes it possible to reduce the amount of gum base used, and therefore also the amount of flavors to use.

Another advantage afforded by the use of the confectionery according to the invention in a chewing gum recipe is the creation of novel textures and novel confectioneries. By varying the amount of gum base in relation to the amount of the confectionery according to the invention, the applicant company has succeeded in obtaining confectioneries of a novel type, having a first part in the form of a chewing paste which ends up dissolving and disappearing, and a second part in the form of a gum base which is the residue which is disposed of once consumption has finished.

In the present invention, the term chewing gum is used to denote both chewing gums and bubble gums, without distinction, since the difference between these two types is moreover quite vague. It is usually stated that chewing gums are chewed whereas bubble gums are intended for blowing bubbles, and are therefore traditionally more consumed by young people.

The applicant company, following numerous tests, has indeed succeeded in demonstrating that the confectionery according to the invention could have a particularly advantageous use in the manufacture of chewing gums, since it made it possible to reduce the amount of gum base used in the recipe by up to 70%.

The confectionery according to the invention may therefore be used to prepare a chewing gum containing at most 25% gum base.

When it is known that a portion of the flavors remains trapped in the gum base during chewing, and that they are never released into the saliva, the advantage of using the confectionery according to the invention as an ingredient in the manufacture of a chewing gum is twofold, since by enabling on the one hand the reduction in the content of gum base, it also makes it possible to reduce the amount of flavors used. This leads to a significant reduction in terms of manufacturing costs, and is therefore highly advantageous to manufacturers.

Not only is it possible to use less flavor, but in addition they will be released more rapidly.

Thus, the present invention also relates to a chewing gum composition containing, with the percentages being given as dry weight relative to the total weight of said chewing gum composition:
from 5% to 25%, preferentially from 7% to 22%, of at least one gum base,
from 5% to 90%, preferentially from 20% to 80%, and more preferentially still from 30% to 75% of the confectionery according to the invention,
from 0.1% to 8%, preferentially from 0.1% to 3%, of at least one flavor.

According to a preferred mode, the invention also relates to a process for manufacturing a chewing gum composition, characterized in that it comprises the following steps:
mixing the confectionery according to the invention with the gum base,
rolling or extruding the mixture,
recovering the chewing gums.

Traditionally, the manufacture of chewing gum requires very specific and costly equipment, consisting at least of a kneader, an extruder and a roller. Substituting a portion of the crystalline phase and/or of the gum base in a chewing gum recipe with the confectionery according to the invention also makes it possible to no longer need the typical equipment for manufacturing chewing gum. Indeed, it is possible to use a production line for chewing paste to manufacture the novel chewing gum.

This represents a considerable advantage, because manufacturers having a chewing paste production line will henceforth be able to manufacture chewing gum-type confectioneries.

Thus, the use of the confectionery according to the invention as a replacement for part of the gum base and/or the crystalline phase in a chewing gum recipe affords considerable advantages.

A final advantage is the development of novel types of confectioneries with novel textures. Indeed, by combining both gum base and a confectionery of chewing paste type, it is possible to create all sorts of novel confectioneries by adjusting the proportions of the gum base relative to the chewing paste according to the invention but also by adjusting the way in which these two constituents are combined.

Indeed, in one embodiment of these novel confectioneries, it is possible to mix the gum base with the chewing paste in a mixer, before subsequently giving the chewing gum the desired shape. In this type of novel confectioneries, there will therefore be an intimate mixing of the gum base and the chewing paste.

According to another embodiment of the invention, it is also possible to create a novel confectionery by alternating the layers of gum base and of chewing paste. It may also be envisaged to make the arrangements in the form of layers or also to give various shapes such as twisted shapes.

According to another embodiment, it may also be envisaged to surround a core consisting of gum base with the chewing paste according to the invention, and vice versa.

The advantage of the present invention is therefore extremely great because, on the one hand, it is possible to substitute a part, but preferably all, of the fat initially present in a confectionery of chewing paste type, but on the other hand it may also be envisaged to use this fat-free confectionery, containing a starch hydrolyzate and a fiber, in a chewing gum recipe, to substitute part of the gum base and/or the crystalline phase and thereby create novel textures.

The invention will be yet better understood on reading the following examples, which are illustrative and non-limiting since they only mention some embodiments and some advantageous properties according to the invention.

### EXAMPLE 1

### Sugar-Free Chewing Pastes According to the Invention

The aim is to produce jelly confectioneries of chewing paste type with no added sugar, no longer containing any fat (F) and containing a mixture of a starch hydrolyzate, in particular a DE=2 maltodextrin, and a plant fiber, in particular a branched maltodextrin, according to the invention.

In this example, chewing pastes were produced from a traditional recipe containing fat of biscuitine 521 type, in which the fat of biscuitine 521 type was substituted by the mixture according to the invention.

The control is a conventional sugar-free chewing paste recipe containing fat.

Test 1 relates to chewing pastes no longer containing any fat but still containing gelatin. The fat substitution was therefore total.

Test 2 relates to chewing pastes no longer containing any fat and also not containing any gelatin.

A—Formulae

The formulae used for the control and for tests 1 and 2 are given in table 1.1 below. The calorie contents for the control and for tests 1 and 2 are given in table 1.2 below.

Biscuitine™ 621 is a non-lauric, refined, hydrogenated vegetable fat which has a melting point of 35° C. and is sold by Loders Croklaan B.V., Wormerveer, The Netherlands.

The HLB5 sucrose esters are esters of sucrose and of fatty acids obtained by transesterification of methyl esters and of sucrose, used as non-ionic emulsifiers of fats, and sold by Stearinerie Dubois in Boulogne, France.

The maltodextrin GLUCIDEX 2 is a maltodextrin sold by the applicant company.

Nutriose® FB06 is a branched maltodextrin also sold by the applicant.

The apple flavor is sold by Symrise AG, Clichy-la-Garenne, France.

B—Method
Pour cold drinking water into a tank.
Introduce parts A and B with vigorous stirring. Wait until entirely dissolved and check for the absence of lumps.
Cook the preceding mixture at a determined temperature and at atmospheric pressure so as to obtain a mixture containing 90-94% solids. In this example, the cooking temperature is 138° C. for the control and 126° C. for the two tests. It is also possible to cook the preceding mixture under vacuum at a pressure of −0.5 b. Mix well during the cooking step in order to prevent the mixture from burning.
For the control and test 1 containing gelatin, add the molten gelatin (part C) in solution at 60° C. after the cooking of the preceding mixture and cooling of the latter to a temperature of approximately 80° C.
Once the mass has cooled to below 80° C., add part D.
Cast the chewing paste onto a cooling table until it is at a temperature of between 50 and 60° C.
Draw the chewing paste for 1 minute (50 to 60 movements) so as to obtain good aeration. The aeration can also be obtained in a whipping machine under pressure (1 to 2 bar) in a continuous production process.
Leave the aerated chewing paste to stand in order for it to cool (between 45° C. and 55° C.) and in order for it to recover texture.
Shape, cut and wrap the confectioneries.

C—Tests

For these various tests, the chewing pastes were tasted by a trained jury of 10 individuals who graded the texture in the mouth according to three parameters: sticky nature, hardness, elasticity.

The chewing time, i.e. the time measured between the introduction of the chewing paste into the oral cavity and its total disintegration under “normal” chewing, was also determined using a timer.

D—Analysis

The control confectioneries have a good elastic texture and a fullness in the mouth provided by the presence of fat.

Their elasticity and chewability are in accordance with the expectations of the tasters relating to this type of confectionery and their chewability time was 2 minutes.

The confectioneries of tests 1 and 2 have entirely satisfactory elastic textures relative to consumer expectations and similar to the control confectioneries containing fat.

Although these confectioneries no longer contain fat, they have the same fullness in the mouth as the control confectioneries.

Their chewability time was also measured and is similar to that of the control confectioneries.

Moreover, although the confectioneries of tests 1 and 2 no longer contain fat, they were not judged to be sticky at all.

Finally, no difference was observed relative to the test containing gelatin and that which did not contain it.

This perfectly demonstrates that the use of a mixture of DE=2 maltodextrin and branched maltodextrin according to the invention makes it possible to obtain confectioneries which have a very good elastic texture, an absence of stickiness at the palate or the teeth, and a chewability duration entirely in line with consumer expectations.

The advantage of the invention is therefore perfectly demonstrated.

Moreover, substituting the fat by a mixture of DE=2 maltodextrin and branched maltodextrin according to the invention also makes it possible to substitute the gelatin, since no difference was reported in the presence or absence of gelatin in the confectioneries of tests 1 and 2.

The confectioneries of tests 1 and 2 no longer contain any fat, and do not contain any added sugar either, and are enriched in fibers.

The advantage of the invention is therefore perfectly demonstrated.

### EXAMPLE 2

### Chewing Pastes with Sugar According to the Invention

The aim is to produce jelly confectioneries of chewing paste type, this time with added sugar, no longer containing any fat and containing a mixture of DE=2 maltodextrin and branched maltodextrins according to the invention.

In this example, chewing pastes were produced from a traditional recipe containing fat of biscuitine 521 type, in which the fat of biscuitine 521 type was substituted by the mixture according to the invention.

The control is a conventional chewing paste recipe with sugar and containing fat.

Test 1 relates to chewing pastes no longer containing any fat but still containing gelatin. The fat substitution was therefore total.

Test 2 relates to chewing pastes no longer containing any fat and also not containing any gelatin.

A—Formulae

The formulae used for the control and for tests 3 and 4 are given in table 2.1 below. The calorie contents for the control and for tests 3 and 4 are given in table 2.2 below.

The glucose syrup c4280 is a glucose syrup sold by the applicant company.

B—Method
Pour cold drinking water into a tank.
Introduce parts A and B with vigorous stirring. Wait until entirely dissolved and check for the absence of lumps.
Cook the preceding mixture at a determined temperature and at atmospheric pressure so as to obtain a mixture containing 90-94% solids. In this example, the cooking temperature is 128° C. for the control and 122° C. for the two tests. It is also possible to cook the preceding mixture under vacuum at a pressure of −0.5 b. Mix well during the cooking step in order to prevent the mixture from burning.
For the control and test 3 containing gelatin, add the molten gelatin (part C) in solution at 60° C. after the cooking of the preceding mixture and cooling of the latter to a temperature of approximately 80° C.
Once the mass has cooled to below 80° C., add part D.
Cast the chewing paste onto a cooling table until it is at a temperature of between 50 and 60° C.
Draw the chewing paste for 1 minute (50 to 60 movements) so as to obtain good aeration. The aeration can also be obtained in a whipping machine under pressure (1 to 2 bar) in a continuous production process.
Leave the aerated chewing paste to stand in order for it to cool (between 45° C. and 55° C.) and in order for it to recover texture.
Shape, cut and wrap the confectioneries.

C—Tests

For these various tests, the chewing pastes were tasted by a trained jury of 10 individuals who graded the texture in the mouth according to three parameters: sticky nature, hardness, elasticity.

The chewing time, i.e. the time measured between the introduction of the chewing paste into the oral cavity and its total disintegration under “normal” chewing, was also determined using a timer.

D—Analysis

The analyses are identical to those of example 1.

The control confectioneries have a good elastic texture and a fullness in the mouth provided by the presence of fat.

Their elasticity and chewability are in accordance with the expectations of the tasters relating to this type of confectionery and their chewability time was 2 minutes.

The confectioneries of tests 3 and 4 have entirely satisfactory elastic textures relative to consumer expectations and similar to the control confectioneries containing fat.

Although these confectioneries no longer contain fat, they have the same fullness in the mouth as the control confectioneries.

Their chewability time was also measured and is similar to that of the control confectioneries.

Moreover, although the confectioneries of tests 3 and 4 no longer contain fat, they were not judged to be sticky at all.

Finally, no difference was observed relative to the test containing gelatin and that which did not contain it.

This perfectly demonstrates that the use of a mixture of DE=2 maltodextrin and branched maltodextrins according to the invention makes it possible to obtain confectioneries which have a very good elastic texture, an absence of stickiness at the palate or the teeth, and a chewability duration entirely in line with consumer expectations.

The advantage of the invention is therefore perfectly demonstrated.

Moreover, substituting the fat by a mixture of DE =2 maltodextrin and branched maltodextrins according to the invention also makes it possible to substitute the gelatin, since no difference was reported in the presence or absence of gelatin in the confectioneries of tests 1 and 2.

The confectioneries of tests 3 and 4 no longer contain any fat, and are enriched in fibers.

The advantage of the invention is therefore perfectly demonstrated.

TABLE 1.1
Chewing paste compositions without added sugars according to the invention (example 1)

| | | | | Test 1 (with gelatin | | Test 2 (without gelatin | |
|---|---|---|---|---|---|---|---|
| | | Control | | and without F) | | and without F) | |
| | | | Final | | Final | | Final |
| | | Used | composition | Used | composition | Used | composition |
| | INGREDIENTS | (g) | (%) | (g) | (%) | (g) | (%) |
| Part A | Lycasin 80/55 maltitol | 799 | 71.9 | 778 | 69.6 | 800 | 69.9 |
| | syrup | | | | | | |
| | Mannitol 60 | 88 | 10.5 | 100 | 12.4 | 120 | 14 |
| Part B | Biscuitine ™ 521 | 57 | 6.8 | — | — | — | — |
| | HLB5 Sucrose ester | 2 | 0.2 | 1 | 0.1 | 1 | 0.1 |
| | Glucidex 2 maltodextrin | — | | 42 | 4.9 | 42 | 4.9 |
| | Nutriose ® FB06 | — | | 20 | 2.3 | 20 | 2.3 |
| Part C | Gelatin 175 bl at 40% | 42 | 2 | 42 | 2 | — | — |
| Part D | Mannitol 60 starter | 4 | 0.5 | 10 | 1 | 10 | 1 |
| | Apple flavor | 4 | 0.4 | 4 | 0.4 | 4 | 0.4 |
| | Anhydrous citric acid | 4 | 0.5 | 3 | 0.3 | 3 | 0.3 |
| | Calculated residual water | | 7.2 | | 7 | | 7 |
| | TOTAL | 1000 | 100 | 1000 | 100 | 1000 | 100 |

TABLE 1.2
Calorie content of the chewing paste compositions without
added sugars according to the invention (example 1)

| | | Test 1 (with | Test 2 (without |
|---|---|---|---|
| | | gelatin and | gelatin and |
| | Control | without F) | without F) |
| Calories | 226 | 189 | 186 |
| (Kcal) | | | |
| Proteins | 1.8 | 1.8 | 0.0 |
| F | 7.0 | 0.1 | 0.1 |
| Sugars | 0.0 | 5.0 | 5.0 |
| of which DP | 0.0 | 0.0 | 0.0 |
| 1.2 | | | |
| Fibers | 0.0 | 1.9 | 1.9 |
| insoluble | 0.0 | 0.0 | 0.0 |
| fibers | | | |
| soluble | 0.0 | 1.9 | 1.9 |
| fibers | | | |
| Polyols | 64.8 | 65.4 | 67.3 |

TABLE 2.1
Chewing paste compositions with sugar according to the invention (example 2)

| | | | | Test 3 (with gelatin | | Test 4 (without gelatin | |
|---|---|---|---|---|---|---|---|
| | | Control | | and without F) | | and without F) | |
| | | | Final | | Final | | Final |
| | | Used | composition | Used | composition | Used | composition |
| | INGREDIENTS | (g) | (%) | (g) | (%) | (g) | (%) |
| Part A | Glucose c4280 | 370 | 34.4 | 358 | 33.7 | 370 | 34.6 |
| | Sucrose | 416 | 48.3 | 411 | 48.7 | 426 | 49.8 |
| | Water | 100 | | 113 | | 128 | |
| Part B | Biscuitine ™ 521 | 57 | 6.6 | — | — | — | — |
| | HLB5 Sucrose ester | 2 | 0.2 | 1 | 0.1 | 1 | 0.1 |
| | Glucidex 2 maltodextrin | — | | 42 | 4.7 | 42 | 4.7 |
| | Nutriose ® FB06 | — | | 20 | 2.2 | 20 | 2.2 |
| Part C | Gelatin 175 bl at 40% | 42 | 2 | 42 | 2 | — | — |
| Part D | Icing sugar starter | 4 | 0.5 | 4 | 0.5 | 4 | 0.5 |
| | Apple flavor | 3 | 0.3 | 3 | 0.4 | 3 | 0.4 |
| | Anhydrous citric acid | 6 | 0.7 | 6 | 0.7 | 6 | 0.7 |
| | Calculated residual water | | 7 | | 7 | | 7 |
| | TOTAL | 1000 | 100 | 1000 | 100 | 1000 | 100 |

TABLE 2.2
Calorie content of chewing paste compositions with
sugar according to the invention (example 2)

| | | Test 3 (with | Test 4 (without |
|---|---|---|---|
| | | gelatin and | gelatin and |
| | Control | without F) | without F) |
| Calories | 374 | 336 | 336 |
| (Kcal) | | | |
| Proteins | 1.8 | 1.8 | 0.0 |
| F | 6.8 | 0.1 | 0.1 |
| Sugars | 76.3 | 81.0 | 82.9 |
| of which DP | 57.1 | 57.4 | 58.7 |
| 1.2 | | | |
| Fibers | 0.0 | 1.8 | 1.8 |
| insoluble | 0.0 | 0.0 | 0.0 |
| fibers | | | |
| soluble | 0.0 | 1.8 | 1.8 |
| fibers | | | |
| Polyols | 0.0 | 0.0 | 0.0 |

### EXAMPLE 3

### Chewing Gums with Fat-Free Chewing Pastes According to the Invention

The aim of the examples below is to produce chewing gums, substituting a part or all of the crystalline phase with a confectionery according to the invention, in particular a jelly confectionery of fat-free chewing paste type (CP without F) in sugar or sugar-free versions and with and without gelatin.

In the following examples, the polyols were replaced, totally or partially, with chewing paste. Novel assemblies are possible because the absence of fat makes it possible to redefine the mixtures and ratios.

The gum base content is no longer a limiting factor. This freedom of formulation widens the field of chewing gum textures.

### EXAMPLE 3.1

### Chewing Gums with Fat-Free Chewing Pastes and Constant Gum Base Contents

The control is a conventional sugar-free chewing gum recipe characterized by a high initial hardness and a long hydration duration.

The formulae are given in table 3.1 below.

Test 0 corresponds to a mix of sugar-free chewing gum and a conventional sugar-free chewing paste, that is to say containing fat and as produced for the control of test 1 above.

In this case, the fat of the chewing paste, solvent of the constituents of the gum base, has made an impact on the texture of the product. The chew is very supple and sticky, with loss of elasticity. The gum base content must be high to counteract the effect of the fat. As will already have been appreciated, the degree of incorporation of conventional chewing paste is limited.

Tests 1 to 5 relate to chewing gums containing sugar-free and fat-free chewing paste as in test 2 of example 1 above, the gum base content of which has been kept at the standard level, that is to say at 30% by weight of all the ingredients used.

Test 1 corresponds to a very partial replacement of the crystalline phase.

Test 2 corresponds to retaining the mannitol to optimize passage through the machine and avoid stickiness of the mix.

Test 3 relates to a total replacement of the crystalline phase.

Test 4 relates to a chewing gum in which inclusions may be made to lead to a visual or sensory effect. In this case, Maltitol P200, sold by the applicant, leads to a crunchy effect.

Test 5 relates to a chewing gum with fibers.

All the combinations, inclusions, colorings, etc., already possible for a conventional chewing gum, may be retained and developed.

The gum base Solsona is sold by CAFOSA, Spain. SolsonaT is a gum base with talc for sugar-free products.

### EXAMPLE 3.2

### Chewing Gums with Fat-Free Chewing Pastes with a Variable Gum Base Content

This series of tests relates to chewing gums with variable gum base contents. Indeed, it will be demonstrated that the gum base content is no longer a constraint. It is only necessary to ensure cohesion in the mouth and the minimum volume required to be able to chew the gum base.

This flexibility also introduces flexibility in terms of the content and support for flavors used.

The texture of the product is provided as much by the gum base as by the chewing paste according to the present invention, as a function of the degree of incorporation.

The formulae are given in table 3.2 below.

The chewing paste used for these different formulations is a sugar-free and fat-free chewing paste as defined in test 2 of example 1 above.

Test 6 shows a chewing gum with a low gum base content (only 10% by weight of all the ingredients used) without liquid flavor in the gum base part.

Test 7 is also a chewing gum having a reduced gum base content (15%) but with a crystalline polyol portion. The content of liquid flavor has been reduced.

Test 8 corresponds to a chewing gum containing a large amount of chewing paste but with a gum base content corresponding to a chewing gum with sugar, that is to say 20%.

### EXAMPLE 3.3

### Chewing Gums with Fat-Free Chewing Pastes and any Format

This example relates to the use of a chewing paste according to the invention in combination with compounds traditionally used in the manufacture of chewing gums, while adjusting the formats of the confectioneries obtained.

Since products with or without gum base have similar textures, this makes it possible to create multi-dimensional chewing gums much more easily (multilayer, CP/CG or CG/CP filling, twists, etc.). The twisted product for example winds two sausage-shaped pieces to form a twisted product.

Test 9 shows a two-layer product, 50% chewing gum and 50%

CP.

Test 10 shows a chewing-gum product with 30% CP.

There are no limitations on the composition, the mix, the positioning of the layers, etc.

The formulae are given in table 3.3 below.

The chewing paste used for these different formulations is a sugar-free and fat-free chewing paste as in test 2 of example 1 above.

### EXAMPLE 3.4

### Method for Preparing Different Chewing Gums

The different mixtures are prepared in a Z-arm kneader.

The kneader jacket is brought to 45° C.

The gum base is introduced into the kneader with a portion of the chewing paste.

The liquid flavors are introduced then the rest of the chewing paste, and finally the powders (polyols, powder flavors, acids, etc.).

The mixer is stopped when the mixture is homogeneous.

The temperature of the mixture does not exceed 50° C.

This phase is comparable to the traditional manufacture of chewing gum. It may be carried out in discontinuous or continuous mode in mixers or co-kneaders.

Shaping depends on the texture of the paste and the format chosen (rolled or extruded).

The chewing gum/chewing paste mixture makes it possible to produce chewing gums on chewing paste shaping lines. Indeed, the final texture of the product is close to that of a chewing paste and the product may be wrapped in the same formats as chewing pastes.

### EXAMPLE 3.5

### Tasting

All the different chewing gums according to the invention were tasted and graded by a trained jury.

They were all judged to be very satisfactory and of a quality at least identical to that of the control chewing gums.

The confectioneries of example 3.3, for their part, were very well received by the tasting jury. Although these are novel confectioneries both in terms of texture and shape, their tasting was very positive.

All the examples presented above demonstrate that it is perfectly possible to:
substitute a part or all of the crystalline phase in a chewing gum recipe,
substitute a part of the gum base in a chewing gum recipe,
create novel textures by combining a chewing gum recipe with the fat-free chewing paste of the invention.

The substitution of a part of the crystalline phase and/or of the gum base does not interfere with the qualities of the finished product.

Indeed, measurements of water loss and also of water reuptake in wet or dry conditions showed that the chewing gums containing the chewing paste according to the invention were just as stable, or even more stable, than a traditional chewing gum of the prior art containing a sorbitol crystalline phase.

TABLE 3.1
Chewing gums with fat-free chewing pastes according
to the invention with a constant gum base content

| | Control sugar- | | | | | | |
|---|---|---|---|---|---|---|---|
| Example 3.1 | free chewing gum | Test 0 | Test 1 | Test 2 | Test 3 | Test 4 | Test 5 |
| Composition (g) | 100 | 100 | 100 | 100 | 100 | 100 | 100 |
| Gum base (Solsona) | 30 | 30 | 30 | 30 | 30 | 30 | 30 |
| NEOSORB ® P60W | 45.5 | 38.55 | 35 | | | | |
| sorbitol | | | | | | | |
| Mannitol 60 | 10 | | | 10 | | 10 | 10 |
| Maltitol P200 | | | | | | 10 | |
| Nutriose ® FB06 | | | | | | | 20 |
| LYCASIN ® 85/55 | 6 | | | | | | |
| type maltitol syrup | | | | | | | |
| Glycerol | 2 | | | | | | |
| Emulsifier: liquid | 0.05 | | | | | | |
| sunflower lecithin | | | | | | | |
| Sucralose | 0.2 | 0.2 | 0.2 | 0.2 | 0.2 | 0.2 | 0.2 |
| Citric acid | 0.8 | 0.8 | 0.8 | 0.8 | 0.8 | 0.8 | 0.8 |
| 4000TP coated citric | 0.8 | 0.8 | 0.8 | 0.8 | | 0.8 | 0.8 |
| acid | | | | | | | |
| Crystal menthol flavor | 0.05 | 0.05 | 0.05 | 0.05 | 0.05 | 0.05 | 0.05 |
| sold by Mane | | | | | | | |
| Physcool synergy | 0.2 | 0.2 | 0.2 | 0.2 | | 0.2 | 0.2 |
| M-0059829, Mane | | | | | | | |
| Liquid lemon flavor | 1.2 | 1.2 | 1.2 | 1.2 | 0.8 | 1.2 | 1.2 |
| M-0057478, Mane | | | | | | | |
| Flavor N-capture SD | 1.5 | 1.5 | 1.5 | 1.5 | 1.5 | 1.5 | 1.5 |
| M-057492, Mane | | | | | | | |
| Flavor Powercaps 1000 | 1.5 | 1.5 | 1.5 | 1.5 | | 1.5 | 1.5 |
| E-1406208, Mane | | | | | | | |
| Dye | 0.2 | 0.2 | 0.2 | 0.2 | 0.2 | 0.2 | 0.2 |
| Sugar-free CP with F | | 25 | | | | | |
| (control from example | | | | | | | |
| 1) | | | | | | | |
| Sugar-free and F-free | | | 28.55 | 53.55 | 66.45 | 43.55 | 33.55 |
| CP (test 2 from example | | | | | | | |
| 1) | | | | | | | |
| % chewing paste | 0 | 25 | 28.55 | 53.55 | 66.45 | 43.55 | 33.55 |
| % water in finished | 0.9 | 1.75 | 2 | 3.75 | 4.65 | 3.05 | 2.35 |
| product | | | | | | | |

Physcool synergy M-0059829, Mane: this is a liquid refreshing agent sold by Mane.
Flavor N-capture SD M-057492, Mane: this is a dry powder spray flavor with gum arabic base sold by Mane.
Flavor Powercaps 1000 E-1406208, Mane: these are gelatin flavor capsules sold by Mane.

TABLE 3.2
Chewing gums with fat-free chewing pastes according
to the invention with variable gum base content

| | Control | | | |
|---|---|---|---|---|
| | sugar-free | | | |
| EXAMPLE 3.2 | chewing gum | Test 6 | Test 7 | Test 8 |
| Composition (g) | 100 | 100 | 100 | 100 |
| Gum base (Solsona) | 30 | 10 | 15 | 20 |
| NEOSORB ® P60W | 45.38 | | | |
| sorbitol | | | | |
| Mannitol 60 | 10 | | 15 | 6.5 |
| LYCASIN ® 85/55 type | 6 | | | |
| maltitol syrup | | | | |
| Glycerol | 2 | | | |
| Acesulfame K | 0.12 | 0.12 | 0.12 | 0.12 |
| Sucralose | 0.15 | 0.15 | 0.15 | 0.15 |
| Citric acid | 0.8 | | 0.8 | 0.8 |
| 4000TP coated | 0.8 | | 0.8 | |
| citric acid | | | | |
| Crystal menthol | 0.05 | | 0.05 | |
| flavor sold by Mane | | | | |
| Physcool synergy | 0.3 | | 0.3 | 0.3 |
| M-0059829, Mane | | | | |
| Strawberry | 1.2 | | 0.6 | 0.8 |
| E-1406206 Flavor, | | | | |
| Mane | | | | |
| Flavor Powergran GL | 1.5 | 1.5 | 1.5 | 1 |
| M-0059849, Mane | | | | |
| Flavor N-capture | 1.5 | 1.5 | 1.5 | |
| SD-E 1402207, Mane | | | | |
| Dye | 0.2 | 0.2 | 0.2 | 0.2 |
| Sugar-free and | | 86.53 | 63.98 | 70.13 |
| F-free CP (test 2 | | | | |
| from example 1) | | | | |
| % water in finished | 0.9 | 6.06 | 4.48 | 4.91 |
| product | | | | |

TABLE 3.3
Chewing gums with fat-free chewing pastes
according to the invention with any format

| | Control | | |
|---|---|---|---|
| | sugar-free | | |
| EXAMPLE 3.3 | chewing gum | Test 9 | Test 10 |
| Composition (g) | 100 | 100 | 100 |
| Gum base (Solsona) | 30 | 15 | 21 |
| NEOSORB ® P60W | 45.5 | 22.75 | 31.85 |
| sorbitol | | | |
| Mannitol 60 | 10 | 5 | 7 |
| LYCASIN ® 85/55 type | 6 | 3 | 4.2 |
| maltitol syrup | | | |
| Glycerol | 2 | 1 | 1.4 |
| Emulsifier: liquid | 0.05 | 0.025 | 0.035 |
| sunflower lecithin | | | |
| Sucralose | 0.2 | 0.1 | 0.14 |
| Citric acid | 0.8 | 0.4 | 0.56 |
| 4000TP coated | 0.8 | 0.4 | 0.56 |
| citric acid | | | |
| Crystal menthol | 0.05 | 0.025 | 0.035 |
| flavor sold by Mane | | | |
| Physcool synergy | 0.2 | 0.1 | 0.14 |
| M-0059829, Mane | | | |
| Liquid lemon flavor | 1.2 | 0.6 | 0.84 |
| M-0057478, Mane | | | |
| Flavor N-capture SD | 1.5 | 0.75 | 1.05 |
| M-057492, Mane | | | |
| Flavor Powercaps 1000 | 1.5 | 0.75 | 1.05 |
| E-1406208, Mane | | | |
| Dye | 0.2 | 0.1 | 0.14 |
| Sugar-free and | | 50 | 30 |
| F-free CP (test 2 | | | |
| from example 1) | | | |

1-17. (canceled)

18. A chewing paste having a reduced or zero fat content, wherein said chewing paste comprises a mixture of a maltodextrin and a plant fiber.

19. The chewing paste as claimed in claim 18, wherein said chewing paste comprises from 0.1% to 25% of a maltodextrin, the percentages being expressed by weight relative to the total weight of the chewing paste.

20. The chewing paste as claimed in claim 18, wherein said chewing paste comprises from 0.1% to 50% of a plant fiber, the percentages being expressed by weight relative to the total weight of the chewing paste.

21. The chewing paste as claimed in claim 18, wherein said chewing paste does not contain gelatin.

22. The chewing paste as claimed in claim 18, wherein said chewing pasteis sugar-free.

23. The chewing paste as claimed in claim 22, wherein the maltodextrin has a DE of less than 10.

24. The chewing paste as claimed in claim 23, wherein the maltodextrin has a DE equal to 2.

25. The chewing paste as claimed in claim 18, wherein the plant fiber is chosen from soluble fibers, insoluble fibers, or mixtures thereof.

26. The chewing paste as claimed in claim 25, wherein said insoluble plant fiber is chosen from resistant starches, cereal fibers, fruit fibers, vegetable fibers, leguminous plant fibers, or mixtures thereof.

27. The chewing paste as claimed in claim 25, wherein said soluble plant fiber is chosen from fructans, including fructooligosaccharides (FOSs) and inulin, glucooligosaccharides (GOSs), isomaltooligosaccharides (IMOs), transgalactooligosaccharides (TOSs), pyrodextrins, polydextrose, branched maltodextrins, indigestible dextrins and soluble oligosaccharides derived from oleaginous plants or protein-producing plants.

28. The chewing paste as claimed in claim 27, wherein the plant fiber is a branched maltodextrin.

29. The chewing paste as claimed in claim 18, wherein said chewing paste also contains a gum base, in particular from 5% to 50% by weight of gum base.

30. The chewing paste as claimed in claim 29, wherein said chewing paste does not contain polyols.

31. Substitute for fat in a chewing paste comprising a mixture of a maltodextrin and a plant fiber.

32. A chewing gum composition containing, with the percentages being given as dry weight relative to the total weight of said chewing gum composition:
from 5% to 25% of at least one gum base,
from 5% to 90% and more preferentially still from 30% to 75% of the chewing paste as claimed in claim 18,
from 0.1% to 8% of at least one flavor.

33. A process for manufacturing the chewing gum composition as claimed in claim 32, wherein said process comprises the following steps:
mixing a chewing paste with the gum base, the chewing paste having a reduced or zero fat content, wherein said chewing paste comprises a mixture of a maltodextrin and a plant fiber,
rolling or extruding the mixture,
recovering the chewing gums.

34. The chewing paste as claimed in claim 19, wherein said chewing paste comprises from 2% to 10% of a maltodextrin.

35. The chewing paste as claimed in claim 19, wherein said chewing paste comprises from 3% to 8% of a maltodextrin.

36. The chewing paste as claimed in claim 20, wherein said chewing paste comprises from 1% to 10% of a plant fiber, the percentages being expressed by weight relative to the total weight of the chewing paste.

37. The chewing paste as claimed in claim 20, wherein said chewing paste comprises from 1% to 6% of a plant fiber, the percentages being expressed by weight relative to the total weight of the chewing paste.
